(19) United States
(12) Patent Application Publication
(10) Pub. No.: US 2015/0116235 A1
(43) Pub. Date: Apr. 30, 2015

(54) INFORMATION APPARATUS

(71) Applicants: Hiroki Fujisawa, Tokyo (JP); Mitsuo Shimotani, Tokyo (JP); Masakazu Shoji, Tokyo (JP); Keisuke Kobayashi, Tokyo (JP); Yuji Nobe, Tokyo (JP)

(72) Inventors: Hiroki Fujisawa, Tokyo (JP); Mitsuo Shimotani, Tokyo (JP); Masakazu Shoji, Tokyo (JP); Keisuke Kobayashi, Tokyo (JP); Yuji Nobe, Tokyo (JP)

(73) Assignee: Mitsubishi Electric Corporation, Tokyo (JP)

(21) Appl. No.: 14/403,086

(22) PCT Filed: Sep. 4, 2012
(86) PCT No.: PCT/JP2012/072471

§ 371 Date: Nov. 21, 2014

(51) Int. Cl. G06F 3/041

(52) U.S. Cl. CPC G06F 3/041
USPC 345/173

(57) ABSTRACT

An information apparatus includes a liquid crystal display unit 6; a touch panel 3 that is mounted on the display surface of the liquid crystal display unit 6, that has a touch operation area wider than the display area of the liquid crystal display unit 6, and that has a specific operation handling section 3b which is formed on an area corresponding to an extra-display area of the touch operation area and which accepts an operation for a specific operation item of an information apparatus 1; a controller 7 that carries out control in a manner that causes the specific operation handling section 3b to accept an operation corresponding to a specific operation item of external equipment 2.

### TECHNICAL FIELD

The present invention relates to an information apparatus capable of operating externally connected equipment (referred to as external equipment from now on).

### BACKGROUND ART

For example, a portable terminal device described in a Patent Document 1 displays a communication state between it and external equipment on a display unit, or shows the communication state in emission colors or emission modes of light emitting devices.

In addition, a Patent Document 2 discloses an onboard information apparatus that comprises a switch for switching a destination of the output of a control signal and an address signal designating a memory address, which are output from a rewriting device working as the external equipment, and that is capable of giving information on which one of the two devices, its own CPU and the rewriting device, gains access to the hard disk, by altering a display mode of a display depending on the switching state of the switch.

### PRIOR ART DOCUMENT

### Patent Document

Patent Document 1: Japanese Patent Laid-Open No. 2001-317952.

Patent Document 2: Japanese Patent Laid-Open No. 2006-182121.

### DISCLOSURE OF THE INVENTION

### Problems to be Solved by the Invention

As the external equipment externally connected to the information apparatus, there is a cellular phone or a smartphone. The external equipment generally comprises, in addition to an operating section that displays an image and accepts a touch operation, a configuration that accepts an operation by fixedly assigning specific basic operation items to hardware keys.

For example, as for the basic operation items such as “menu display”, “search”, and “undo”, they are generally assigned to hardware keys fixedly rather than displaying operation icons on a screen to be operated. This is because it is convenient for a user to be able to operate the specific basic operation items always independently of the image display.

The conventional techniques typified by the Patent Documents 1 and 2 can comprehend, whether the external equipment is in an operable state or not from the display mode of the display unit or from the emission mode of the light emitting devices.

However, in the conventional techniques, the information apparatus side that operates the external equipment does not distinguish the specific basic operation items of the external equipment from the ordinary operation items which are displayed on the screen to accept an operation. Accordingly, the information apparatus cannot enjoy the convenience due to accepting the operation separately depending on these operation items.

The present invention is implemented to solve the foregoing problems. Therefore it is an object of the present invention to provide an information apparatus capable of improving the convenience of operation of the external equipment.

### Means For Solving the Problem

An information apparatus in accordance with the present invention comprises, in an information apparatus whose operation is performed by connecting it to external equipment through a wire or wireless connection: a display unit; a touch panel that is mounted on a display surface of the display unit, that has a touch operation area wider than a display area of the display unit, and that has a specific operation handling section which is formed on an area corresponding to an extra-display area of the touch operation area and which accepts an operation for a specific operation item of the information apparatus; and a controller that carries out control in a manner that causes the specific operation handling section to accept an operation corresponding to a specific operation item of the external equipment.

### Advantages of the Invention

According to the present invention, it offers an advantage of being able to improve the convenience of the operation of the external equipment.

### BRIEF DESCRIPTION OF THE DRAWINGS

FIG. 1 is a diagram showing an outline of a display system using an information apparatus of an embodiment 1 in accordance with the present invention;

FIG. 2 is a block diagram showing a configuration of the information apparatus of the embodiment 1 and external equipment;

FIG. 3 is a diagram showing an operation mode of the external equipment displayed on the information apparatus of the embodiment 1;

FIG. 4 is a diagram showing another operation mode of the external equipment displayed on the information apparatus of the embodiment 1; and

FIG. 5 is a diagram showing an operation mode of the external equipment displayed on an information apparatus of an embodiment 2 in accordance with the present invention.

### BEST MODE FOR CARRYING OUT THE INVENTION

The best mode for carrying out the invention will now be described with reference to the accompanying drawings to explain the present invention in more detail.

### Embodiment 1

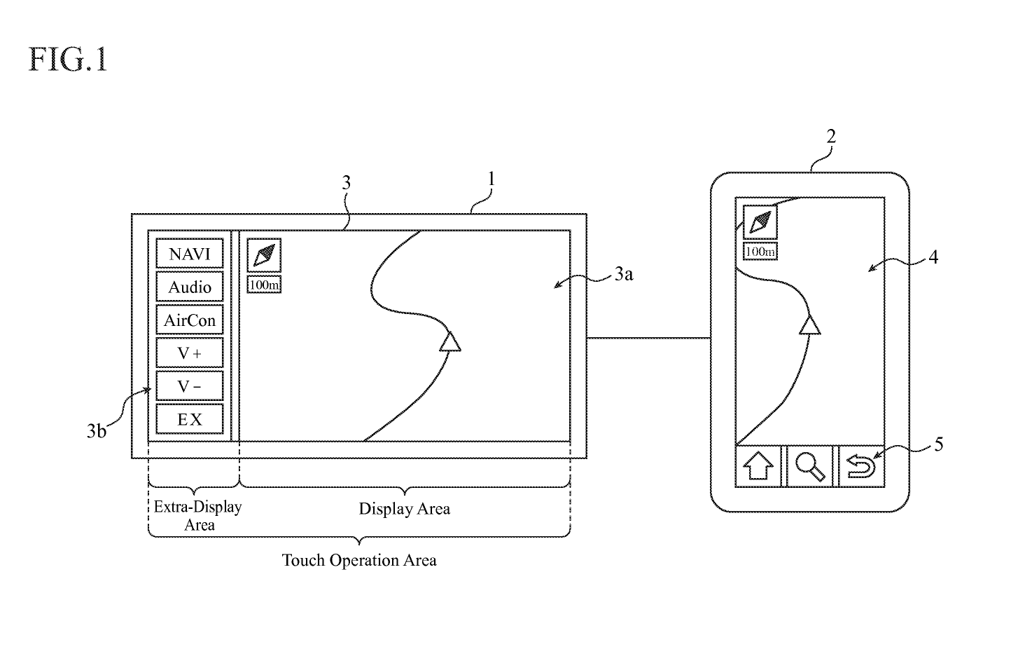

FIG. 1 is a diagram showing an outline of a display system using an information apparatus of an embodiment 1 in accordance with the present invention. In FIG. 1, the information apparatus 1, which is an information apparatus mounted on a mobile unit (vehicle, for example), is connected to each of a navigation system, audio equipment, air conditioner and external equipment 2 which is taken into a mobile unit, through a wire or wireless connection to execute operation. The information apparatus 1 can also be an onboard information apparatus comprising the navigation system or audio equipment.

A touch panel 3, which is mounted on the screen of the liquid crystal display unit, of the information apparatus 1, accepts an operation of an operation part such as a finger of an operator. As its structure, it has two transparent electrodes superimposed via a spacer, and when depressed with the operation part, the upper and lower transparent electrodes make contact locally, which enables detection of the coordinates at the depressed position.

In addition, as shown in FIG. 1, as for the information apparatus 1, a touch operation area of the touch panel 3 is wider than its display area, and includes an area 3a corresponding to the display area and an area corresponding to an extra-display area comprising a specific operation handling section 3b.

The area 3a corresponding to the display area displays icons or buttons showing operation targets on the display area, and accepts operation using the touch panel 3. For example, touching the icon of an operation target with the operation part, causes the processing corresponding to the icon to be executed.

The specific operation handling section 3b is an operating section that accepts an operation to a specific operation item of the information apparatus 1. The term “specific operation item” in the information apparatus 1 refers to an operation item for executing basic processing in the information apparatus 1.

For example, operation items are mentioned which start the processing for operating each of the navigation system, audio equipment, air conditioner, and external equipment 2 which is connected to the information apparatus 1. In FIG. 1, the operation, items correspond to the “NAVI” button, “Audio” button, “AirCon” button, and “EX” button of the specific operation handling section 3b.

In addition, a basic control operation such as volume control is a specific operation item as well. In FIG. 1, the specific operation handling section 3b has a “V+” button and “V−” button for varying the volume.

On the back of the specific operation handling section 3b, untransparent printing is applied. In the printed section, the untransparent printing that corresponds to symbols or letters indicating the operation items that are accepted by the specific operation handling section 3b is removed. Alternatively, after the untransparent printing corresponding to the symbols or letters is removed, transparent printing is applied.

Incidentally, portions of the symbols or letters designating the operation items transmit light from a light source constituting a lighting unit disposed at the back of the touch panel 3, thereby enabling visual confirmation from the display surface side.

The external equipment 2, which can be a smartphone, cellular phone, tablet PC or mobile information terminal, for example, is an apparatus that is connected to the information apparatus 1 so as to be operated. The touch panel 4, which is mounted on the screen of the display unit of the external equipment 2, accepts an operation with an operation part such as a finger of an operator.

In addition, besides the operating section that accepts a touch operation by displaying on the screen of the display unit, the external equipment 2 comprises a specific operation handling section 5. The specific operation handling section 5 is an operating section that accepts an operation by fixedly assigning the specific basic operation items to hardware keys.

The term “specific operation item” in the external equipment 2 refers to an operation item for executing the basic processing in the external equipment 2. In FIG. 1, among the basic: processing of a smartphone, buttons corresponding to “menu display”, “search”, and “undo” are provided to the specific operation handling section 5.

Incidentally, as in the information apparatus 1, the touch panel 4 of the external equipment 2 can comprise a touch operation area wider than the display area, and can provide the specific operation handling section 5 in the area corresponding to the extra-display area of the touch operation area.

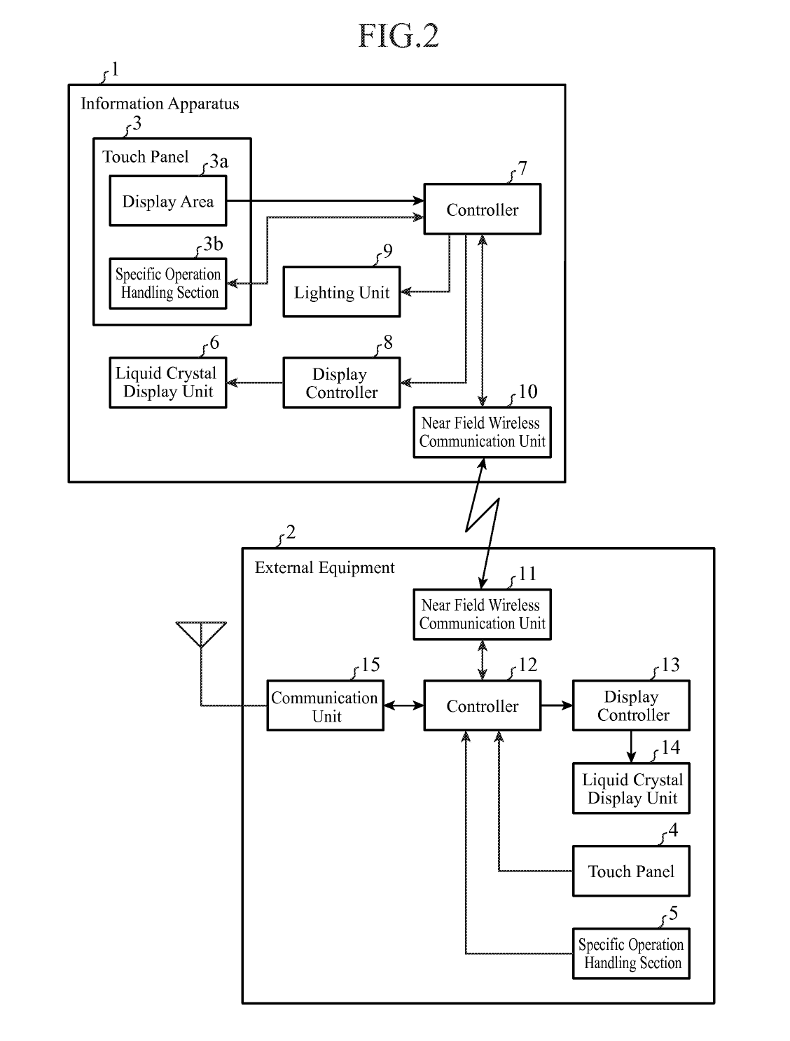

FIG. 2 is a block diagram showing a configuration of the information, apparatus and the external equipment of the embodiment 1, which shows an internal configuration of the information apparatus 1 and that of the external equipment 2. As shown in FIG. 2, the information apparatus 1 comprises the touch panel 3, a liquid crystal, display unit 6, a controller 7, a display controller 8, a lighting unit 9, and a near field wireless communication unit 10.

The touch panel 3, which is mounted on the screen of the liquid crystal display unit 6, is an operation input unit that accepts an operation with an operation part such as a finger of an operator, and comprises the touch operation area wider than the display area of the liquid crystal display unit 6. In addition, the touch operation area comprises the area 3a corresponding to the display area of the liquid crystal display unit 6, and the specific operation handling section 3b formed on the area corresponding to the extra-display area of the liquid crystal display unit 6.

The liquid crystal display unit 6 is a display unit that carries out an image display of the image information apparatus 1. For example, it has a structure that sandwiches a liquid crystal layer between the display surface side transparent substrate and the back side transparent substrate. It comprises an electrode structure for applying an electric field on the liquid crystal layer, color filters, polarizing plates, and so on, and carries out image display by throwing backlight from the back side. Incidentally, although the display unit of the information apparatus 1 consists of the liquid crystal display unit 6, it is not limited to a liquid crystal display, but a plasma display, an organic electroluminescence, and a projection type projector can be used as well.

The controller 7 is a controller that controls the internal components of the information apparatus 1. In addition, the controller 7 carries out control in such a manner as to accept an operation corresponding to the specific operation items of the external equipment 2 by the specific operation handling section 3b. Here, the specific operation items of the external equipment 2 refer to the operation items set in the specific operation handling section 5 of the external equipment 2.

For example, when registering the external equipment 2 in the information apparatus 1 as an operation, target, the specific operation, items of the external equipment 2 are set in advance in the controller 7.

When the external equipment 2 connected to the information apparatus 1 is registered, the controller 7 carries out its control in such a manner that the specific operation handling section 3b accepts operations corresponding to the specific operation items set at the external equipment 2.

The display controller 3 performs the display control processing in accordance with the control of the controller 7, and causes the liquid crystal display unit 6 to display.

The lighting unit 9, which comprises light emitting devices working as a light source on the rear side of the touch panel 3 (the rear side of the specific operation handling section 3b) in the casing of the information apparatus 1, illuminates the specific operation handling section 3b by emitting light in accordance with the control of the controller 7. Incidentally, the lighting unit 9 can emit light in a first emission state and a second emission state which differ from each other.

The near field wireless communication unit 10 is a communication unit that carries out short range communication with the external equipment 2.

For example, it is possible to use wireless communication (wireless LAN, for example) conforming to Bluetooth (registered trademark: not mentioned from now on), IEEE802.11 standards and the like, or wireless communication based on UWB (Ultra Wide Band: ultra wide band wireless). The information apparatus 1 operates the external equipment 2 through the near field wireless communication.

Incidentally, instead of the near field wireless communication unit 10, a configuration is also possible which comprises an interface of a wire connection in the information apparatus 1, and operates the external equipment 2 through the wire communication.

The external equipment 2 comprises as shown in FIG. 2 the touch panel 4, the specific operation handling section 5, a near field wireless communication unit 11, a controller 12, a display controller 13, a liquid crystal display unit 14, and a communication unit 15. The touch panel 4, which is mounted on the screen of the liquid crystal display unit 14, is an operation input unit that accepts an operation with an operation part such as a finger of an operator. Incidentally, as in the information apparatus 1, the touch panel can have a touch operation area wider than the display area of the liquid crystal display unit 14. In addition, the specific operation handling section 5 can be formed in the area corresponding to the extra-display area of the liquid crystal display unit 14 in the touch operation area.

The specific operation handling section 5, which is an operating section that accepts an operation for the specific operation items of the external equipment 2, is configured as an operating section in which the specific operation items are assigned fixedly to hardware keys, for example. The specific operation items are operations relating to the basic processing in the external equipment 2 such as “menu display”, “search”, and “undo” as described above with reference to FIG. 1.

The near field wireless communication unit 11 is a communication unit that, carries out near field wireless communication with the information apparatus 1.

As in the information apparatus 1, it can employ wireless communication conforming to Bluetooth, IEEE802.11 standards or the like, or wireless communication according to UWB.

The controller 12 controls the internal components of the external equipment 2. For example, when the external equipment 2 is connected to the information apparatus 1 and receives instructions from the information apparatus 1, it executes information processing in accordance with the instructions from the information apparatus 1.

The display controller 13 carries out display control processing in accordance with the control of the controller 12 so as to cause the liquid crystal display unit 14 to perform display.

The liquid crystal display unit 14 is a display unit that carries out image display of the external equipment 2. Incidentally, the display unit of the external equipment 2 is not limited to a liquid crystal display, but a plasma display, or an organic electroluminescence can be used as well.

The communication unit 15, which is configured on the assumption that the external equipment 2 is a smartphone, carries out call processing via a telephone antenna.

Next the operation will be described.

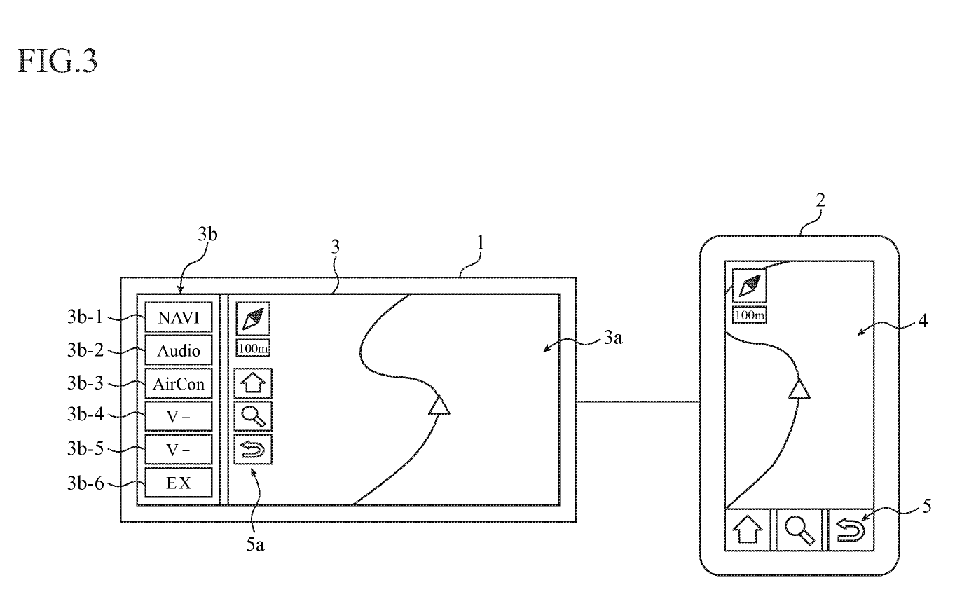

FIG. 3 is a diagram showing an operation mode of the external equipment by the information apparatus of the embodiment 1.

When the information apparatus 1 is connected to the external equipment 2 through the near field wireless communication via the near field wireless communication units 10 and 11, the controller 7 of the information apparatus 1 shifts to the external equipment operation mode that operates the external equipment 2 in response to the operation of the “EX” button 3b-6 in the specific operation handling section 3b.

For example, when the “EX” button 3b-6 is depressed by a touch operation, the controller 7 shifts to the external equipment operation mode (terminal mode), and requests the external equipment 2 to send video data via the near field wireless communication unit 10.

In response to the request, the external equipment 2 sends back the video data displayed on its own liquid crystal display unit 14. According to the video data received from the external equipment 2, the information apparatus 1 displays the image which is being displayed on the external equipment 2 on the display area of the liquid crystal display unit 6.

In this way, assigning the operation for shifting to the external equipment operation mode to the specific operation item makes it possible to shift to the external equipment operation mode without using an image display, thereby being able to improve the convenience of operation of the external equipment 2.

Incidentally, when the “NAVI” button 3b-1 of the specific operation handling section 3b is depressed, for example, the information apparatus 1 moves to the external equipment operation mode that operates the navigation system connected in advance. This enables the operation of the navigation system by the information apparatus 1. In this case, the information apparatus 1 cannot operate the external equipment 2 because the navigation system enters into the operation mode.

In addition, if the navigation system displays a navigation image and a map as in the case of the external equipment 2, the information apparatus 1 displays the same map.

To give visual information about an apparatus that is operable by the information apparatus 1, a configuration is also possible in which the controller 7 controls the emission state of the lighting unit 9.

For example, when the external equipment 2 is not yet connected, the lighting unit 9 does not illuminate the “EX” button 3b-6 of the specific operation handling section 3b, that is, the lighting unit 9 is put into an unlit state.

In contrast, when the external equipment 2 is connected, the lighting unit 9 is put into a red emission state (first emission state) so that, the “EX” button 3b-6 seems red on the display surface.

Furthermore, when the information apparatus 1 is shifted to the external equipment operation mode, and displays the image being displayed on the external equipment 2, it puts the lighting unit 9 into a blue emission state (second emission state) so that the “EX” button 3b-6 seems blue on the surface.

In this way, the transition of the processing can be visually confirmed using the specific operation handling section 3b, and this enables further improvement of the convenience of operation of the external equipment 2.

Incidentally, although the foregoing example shows the case of altering the emission colors as the first and second emission states, it is also possible to make the first emission state continuous lighting and the second emission state blinking. In other words, any emission states are possible which can tell the difference of the processing transition to the connection with the external equipment 2 and the subsequent mode shift.

When shifting to the external equipment operation mode, the controller 7 carries out control in such a manner that, the specific operation handling section 3b accepts an operation corresponding to the specific operation items of the external equipment 2 connected to the information apparatus 1. For example, when registering the external equipment 2 that will be put to an operation target, the specific operation items of the external equipment 2 are set in the controller 7 in advance, and when shifted to the external equipment operation mode, the controller 7 carries out control in such a manner that the specific operation handling section 3b accepts operation corresponding to the specific operation items of the external equipment 2.

In FIG. 3, the operations corresponding to the “menu display”, “search” and “undo” in the external equipment 2 are accepted by the specific operation handling section 3b.

For example, the controller 7 assigns the operation item indicating “menu display” to the “AirCon” button 3b-3, the operation item indicating “search” to the “V+” button 3b-4, and the operation item indicating “undo” to the “V−” button 3b-5.

At this time, the controller 7 may control the display controller S in such a manner as to display the icons 5a corresponding to “menu display”, “search”, and “undo”, respectively, on the display area adjacent to the corresponding buttons as shown in FIG. 3. This enables a user to visually confirm which operation items are assigned to which buttons in the specific operation handling section 3b.

When the “AirCon” button 3b-3 is depressed by the touch operation, the controller 7 instructs the external equipment 2 to execute the menu display processing via the near field wireless communication unit 10. The external equipment 2 executes the menu display processing in accordance with the instructions from the information apparatus 1 and carries out the menu display, and transmits the menu display screen data to the information apparatus 1 via the near field wireless communication unit 11. The controller 7 controls the display controller 8 in such a manner as to carry out display based on the menu display screen data received from the external equipment 2 via the near field wireless communication unit 10, thereby displaying the menu that is being displayed on the external equipment 2 on the display area of the liquid crystal display unit 6.

In addition, when the controller 7 shifts to the external equipment operation mode of the external equipment 2, it may control in such a manner as to enable the touch panel 3 of the information apparatus 1 to accept the types of operation acceptable by the touch panel 4 of the external equipment 2.

For example, when registering the external equipment 2 to be put to an operation target in the information apparatus 1, the types of operation acceptable by the touch panel 4 of the external equipment 2 are set in the controller 7 in advance. When the external equipment 2 connected to the information apparatus 1 is registered, the controller 7 carries out control in such a manner that the touch panel 3 also accepts the types of operation set for the external equipment 2.

As for the types of operation, which is types of operation on the touch operation area, they are distinguished by characteristics of the movement of an operation part, on the touch panel or by a touch pattern thereof.

When a tap, double tap, flick, drag operation, pinch in, pinch out are set as the types of operation acceptable by the external equipment 2, and if a slide of the operation part in continuous contact with the touch operation area of the touch panel 3 is identified from the moving characteristics of the operation part, the controller 7 recognizes that the movement is a drag operation, and executes scrolling or the like corresponding to the movement.

In this way, by making the information apparatus 1 capable of accepting the types of operation of the external equipment 2, the information apparatus 1 can implement the same operation environment as the external equipment 2, thereby being able to further improve the convenience of operation of the external equipment 2.

Although the foregoing description shows the case which displays the icons 5a of the specific operation items of the external equipment 2 on the display area adjacent to the corresponding buttons in the specific operation handling section 3b, this is not essential. For example, a configuration is also possible which shows whether the specific operation items of the information apparatus 1 are active or the specific operation items of the external equipment 2 are active by switching the illumination of the specific operation handling section 3b.

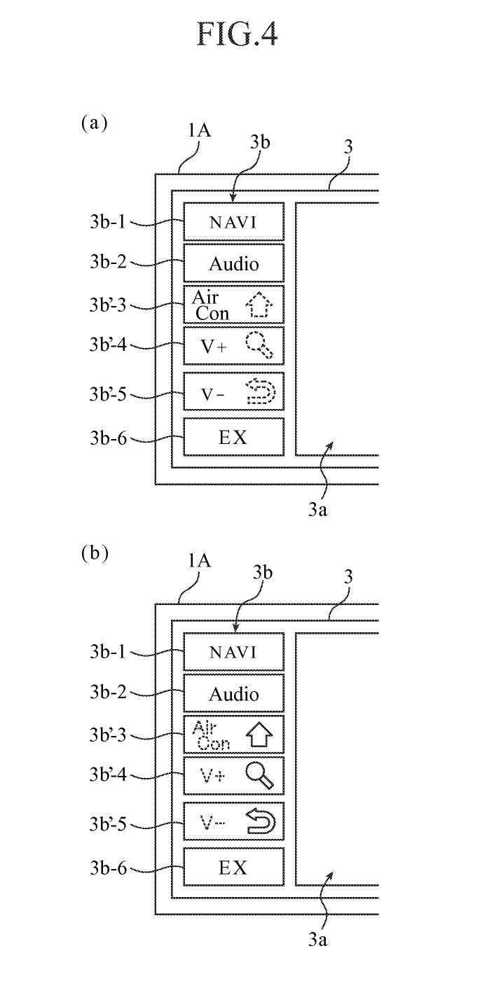

FIG. 4 is a diagram showing another operation mode of the external equipment by the information apparatus of the embodiment 1. The specific operation handling section 3b shown in FIG. 4 indicates active operation items among the specific operation items of the information apparatus 1A and the specific operation items of the external equipment 2 by switching the illumination.

For example, as to the “AirCon” button 3b′-3, “V+” button 3b′-4 and “V−” button 3b′-5, symbols “AirCon”, “V+” and “V−” designating the specific operation items of the information apparatus 1A and symbols designating “menu display”, “search” and “undo” indicating the specific operation items of the external equipment 2 are written in back printing.

As shown in FIG. 4(a), when the external equipment 2 is unconnected, the controller 7 controls the lighting unit 9 in such a manner that it illuminates “AirCon”, “V+” and “V−” on the buttons 3b′-3 to 3b′-5, and does not light the symbols designating “menu display”, “search” and “undo”.

This enables a user to recognize chat the specific operation items of the information apparatus 1A are active.

In contrast, as shown in FIG. 4(b), when the external equipment 2 is connected and the mode is shifted to the external equipment operation mode, the lighting unit 9 does not light “AirCon”, “V+” and “V−” on the buttons 3b′-3 to 3b′-5, but illuminates the symbols designating “menu display”, “search” and “undo”. This enables a user to recognize that the specific operation items of the external equipment 2 are active.

As described above, according to the present embodiment 1, it comprises the liquid crystal display unit 6; the touch panel 3 that is mounted on the display surface of the liquid crystal display unit 6, that has a touch operation area wider than the display area of the liquid crystal display unit 6, and that has the specific operation handling section 3b which is formed on the area corresponding to the extra-display area of the touch operation area and which accepts an operation for a specific operation item of the information apparatus 1; and the controller 7 that carries out control in a manner that causes the specific operation handling section 3b to accept an operation corresponding to the specific operation items of the external equipment 2. With the configuration, it can improve the convenience of operation of the external equipment 2 because the specific operation handling section 3b formed in the area corresponding to the extra-display area can accept an operation to the specific operation items of the external equipment 2, and the operation can always be performed independently of the image display.

In addition, according to the present embodiment 1, the operation accepted by specific operation handling section 3b causes the operation mode to shift to the external equipment operation mode for operating the external equipment 2. Thus, the specific operation handling section 3b formed in the area corresponding to the extra-display area enables shifting to the external equipment operation mode without using the image display, Accordingly, it can improve the convenience of operation of the external equipment 2.

Furthermore, according to the present, embodiment 1, it comprises the lighting unit 9 that is mounted on the back side of the touch panel 3, that illuminates, when the external equipment 2 is connected, the specific operation handling section 3b in the first emission state, and that illuminates, when shifting to the external equipment operation mode for operating the external equipment 2, the specific operation handling section 3b in the second emission state different from the first emission state. Accordingly, it enables a user to visually confirm the transition of the processing utilizing the specific operation handling section 3b, thereby being able to further improve the convenience of operation of the external equipment.

Furthermore, according to the present embodiment 1, when the controller 7 shifts to the external equipment operation mode for operating the external equipment 2, it carries out its control in such a manner that the touch panel 3 of the information apparatus 1 can accept the types of operation acceptable by the touch panel 4 of the external equipment 2. Accordingly, the same operation environment as that of the external equipment 2 is achievable by the information apparatus 1. This enables further improvement of the convenience of operation of the external equipment 2.

### Embodiment 2

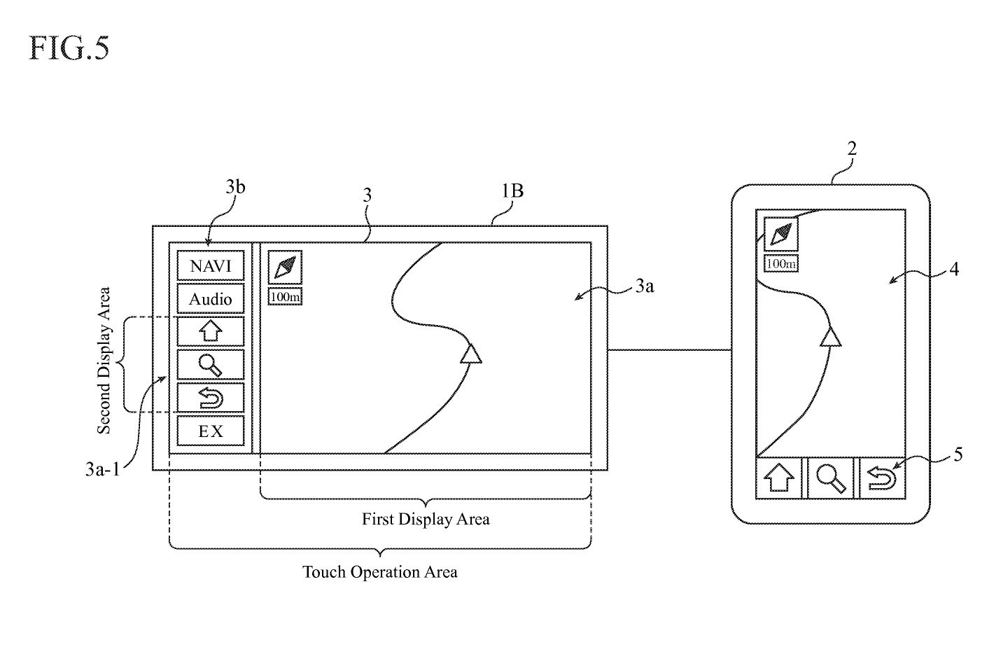

FIG. 5 is a diagram showing the operation mode of the external equipment on the side of the information apparatus of an embodiment 2 in accordance with the present invention. In the information apparatus 1B shown in FIG. 5, the display area of the liquid crystal display unit 6 comprises the first display area 3a and a second display area narrower than the first. For example, the liquid crystal display unit 6 is comprised of a liquid crystal display panel corresponding to the first display area 3a and a liquid crystal display panel corresponding to the second display area. In addition, the second display area is formed in the specific operation handling section 3b, and is provided outside the first display area 3a.

Furthermore, as shown in FIG. 5, the specific operation handling section 3b of the information apparatus 1B is provided outside the first display area 3a in the touch operation area and in an area including the area corresponding to the second display area 3a-1.

When shifting to the external equipment operation mode of the external equipment 2, the controller 7 of the information apparatus 1B carries out control in such a manner that the area 3a-1 corresponding to the second display area of the specific operation handling section 3b accepts an operation corresponding to the specific operation items of the external equipment 2.

For example, when the external equipment 2 is not connected, the controller 7 controls the display controller 8 so as to display “AirCon”, “V+” and “V−” in the second display area. At this time, the specific operation items of the information apparatus 1B become active. Thus, the processing (volume control and the like) relating to the specific operation items of the information apparatus 1B is executed by a touch operation to each button.

When the mode is shifted from this mode to the external equipment operation mode because the external equipment 2 is connected, the controller 7 controls the display controller 8 in such a manner as to display the symbols “menu display”, “search” and “undo” on the second display area as shown in FIG. 5.

In this case, the specific operation items of the external equipment 2 become active so that the processing (such as menu display) relating to the specific operation items of the external equipment 2 is executed by the instructions from the information apparatus 1B corresponding to the touch operation to each button.

As described above, according to the present, embodiment 2, it comprises the liquid crystal display unit 6 that includes the first display area 3a and the second display area narrower than the first display area; the touch panel 3 that is mounted on the display surface of the liquid crystal display unit 6, and that has the specific operation handling section 3b which is formed on the area including the area 3a-1 corresponding to the second display area on the touch operation area and which accepts an operation for the specific operation items of the information apparatus 1B; and the controller 7 that carries out control in a manner that causes the area 3a-1 corresponding to the second display area of the specific operation handling section 3b to accept an operation corresponding to the specific operation items of the external equipment. With the configuration, it can operate while displaying the specific operation items of the external equipment 2 on the dedicated area. Accordingly, it can improve the convenience of operation of the external equipment 2.

Incidentally, it is to be understood that a free combination of the individual embodiments, variations of any components of the individual embodiments or removal of any components of the individual embodiments is possible within the scope of the present invention.

### INDUSTRIAL APPLICABILITY

An information apparatus in accordance with the present invention can improve the convenience of operation of the external equipment. Accordingly, it is suitable for an onboard information apparatus which is placed in an environment that will prevent a user from concentrating on its operation such as during driving.

### DESCRIPTION OF REFERENCE SYMBOLS

1, 1A, 1B information apparatus; 2 external equipment; 3, 4 touch panel; 3a area corresponding to display area (first display area); 3a-1 area, corresponding to second display area; 3b, 5 specific operation handling section; 3b-1-3b-6, 3b′-3, 3b′-4, 3b′-5 button; 6, 14 liquid crystal display unit; 7, 12 controller; 8, 13 display controller; 9 lighting unit; 10, 11 near field wireless communication unit; 15 communication unit.

1. An information apparatus whose operation is performed by connecting it to external equipment through a wire or wireless connection, the information apparatus comprising:
a display unit;
a touch panel that is mounted on a display surface of the display unit, that has a touch operation area wider than a display area of the display unit, and that has a specific operation handling section which is formed on an area corresponding to an extra-display area of the touch operation area and which accepts an operation for a specific operation item of the information apparatus; and
a controller that carries out control in a manner that causes the specific operation handling section to accept an operation corresponding to a specific operation item of the external equipment.

2. The information apparatus according to claim 1, which
shifts to an external equipment operation mode that operates the external equipment in response to the operation accepted by the specific operation handling section.

3. The information apparatus according to claim 1, further comprising:
a lighting unit that is mounted on a back side of the touch panel, that illuminates, when the external equipment is connected, the specific operation handling section in a first emission state, and that illuminates, when shifting to the external equipment operation mode for operating the external equipment, the specific operation handling section in a second emission state different from the first emission state.

4. The information apparatus according to claim 1, wherein
the controller, when shifting to an external equipment operation mode that operates the external equipment, carries out control in a manner that enables the touch panel of the information apparatus to accept a type of operation acceptable by a touch panel of the external equipment.

5. (canceled)
